(19) United States
(12) Patent Application Publication
(10) Pub. No.: US 2017/0068409 A1
(43) Pub. Date: Mar. 9, 2017

(54) COMPUTER IMPLEMENTED SYSTEM AND METHOD FOR DYNAMICALLY MODELING RELATIONSHIPS BETWEEN ENTITIES

(71) Applicant: NUWAFIN HOLDINGS LTD, DUBAI (AE)

(72) Inventor: NANDAKUMAR KRISHNAN NAIR, TRIVANDRAM (IN)

(21) Appl. No.: 14/846,698

(22) Filed: Sep. 4, 2015

(51) Int. Cl. G06F 3/0484; G06F 3/0482

(52) U.S. Cl. CPC G06F 3/0484; G06F 3/0482

(57) ABSTRACT

The embodiments herein envisages a computer implemented system and method for dynamically modeling relationships between a plurality of entities. The system envisaged by the embodiments herein includes a user interface enabling the user to specify at least the information corresponding to the entities to be modeled, and the rules for modeling the entities. A creator enables the user to dynamically create and selectively customize the smart attributes corresponding to the entities. A processor analyzes the smart attributes and the rules specified by the user for modeling the entities, and dynamically decide upon the relationship(s) between the entities to be modeled. The system is configured to dynamically model an inheritance relationship between the entities, and enable the user to dynamically configure entity level access permissions.

### BACKGROUND

Technical Field

The embodiments herein relates to computer implemented systems and methods that enable entity modeling. Particularly, the embodiments herein relates to dynamic entity modeling.

Description of the Related Art

Data modeling is a process typically utilized for defining and analyzing data requirements which are necessary for the implementation of business processes. Data modeling techniques are used to model data in a standard, consistent manner, thereby enabling the data to be managed as a resource. An Entity-Relationship Model (ER model) is a data model used to describe the data requirements of an information system, in an abstract manner. Typically, an entity is an abstraction of the complexities of a given business domain, representing a phenomenon capable of independent existence and being uniquely identified. An entity relationship captures the manner in which the entities are related to one another, and the rules governing such relationships. Typically an entity is associated with a plurality of attributes, which in turn are associated with the corresponding validation rules and derivation rules.

There was felt a need for a system/method that would provide for entities to be dynamically modeled, along with their corresponding attributes and relationships (entity relationship). There was also felt a need for a system that makes use of smart attributes for generating E-R models. There was also felt a need for a system that would make use of different inheritance models and the inheritance rules thereof to enable generation of E-R models. There was also felt a need for a system that makes use of domain specific languages, i.e., customizes the natural language and subsequently utilizes the same for a business domain.

The above mentioned shortcomings, disadvantages and problems are addressed herein and which will be understood by reading and studying the following specification.

### OBJECTIVES OF THE EMBODIMENTS

An object of the embodiments herein, is to provide a system that dynamically models the relationships between the entities.

Still a further object of the embodiments herein is to provide a system that dynamically models the entities using business rules.

Yet another object of the embodiments herein is to envisage a system that provides smart attributes to enable users to seamlessly design E-R models.

Still a further object of the embodiments herein is to provide a system that details the different inheritance models used between various entities.

One more object of the embodiments herein was to provide a system that enables users to model entity relationships using domain specific languages.

Yet another object of the embodiments herein is to provide a system that enables users to specify fine grained permissions for perforating predetermined entity (attribute) level functions.

These and other objects and advantages of the embodiments herein will become readily apparent from the following detailed description taken in conjunction with the accompanying drawings.

### SUMMARY

The embodiments herein envisages a computer implemented system for dynamically modeling relationships between a plurality of entities. The system, in accordance with the embodiments herein comprises a user interface accessible to a user, the user interface configured to enable the user to specify at least the information corresponding to the entities to be modeled; the user interface further configured to enable the user to specify the rules for modeling the entities.

In accordance with the embodiments herein, the system further comprises a creator accessible to the user, the creator configured to enable the user to dynamically create smart attributes corresponding to the entities, wherein the smart attributes are pre-configured in accordance with the rules for modeling the entities, the creator further configured to enable the user to selectively customize the smart attributes.

In accordance with the embodiments herein, the system further comprises a processor cooperating with the creator, the processor configured to analyze the smart attributes and the rules specified by the user for modeling the entities, the processor configured to dynamically decide upon the relationship(s) between the entities to be modeled.

In accordance with the embodiments herein, the system is configured to dynamically model an inheritance relationship between the entities, the system further configured to enable the user to dynamically configure entity level access permissions.

In accordance with the embodiments herein, the graphical user interface is further configured to enable the user to specify the attributes to be present within each of the entities, the user interface further enabling the user to specify the life cycle for the entities.

In accordance with the embodiments herein, the user interface enables the user to specify the rules for modeling the entities, the rules selected from the group consisting of validation rules, derivation rules, inheritance rules and event driven rules.

In accordance with the embodiments herein, the system includes a data storage mechanism configured to selectively store at least the values of each of the attributes of each of the entities, and the information corresponding to the relationship(s) between the entities, and the information corresponding to the smart attributes.

In accordance with the embodiments herein, the user interface further enables a user to specify entity relationships including one-to-one relationship, one-to-many relationship, many-to-many relationship and self-referential relationship.

In accordance with the embodiments herein, the user interface is a natural language based text editor.

The embodiments herein envisages a computer implemented method for dynamically modeling relationships between a plurality of entities. The method, in accordance with the embodiments herein comprises the following computer implemented steps: enabling a user to specify at least the information corresponding to the entities to be modeled; enabling the user to specify the rules for modeling the entities; enabling the user to dynamically create smart attributes corresponding: to the entities, the smart attributes are pre-configured in accordance with the rules for modeling the entities; enabling the user to selectively customize the smart attributes; analyzing the smart attributes and the rules specified by the user for modeling the entities; and dynamically deciding upon the relationship(s) between the entities to be modeled; dynamically modeling an inheritance relationship between the entities; and enabling the user to dynamically configure entity level access permissions.

In accordance with the embodiments herein, the step of enabling a user to specify at least the information corresponding to the entities to be modeled, further includes the step of enabling the user to specify the attributes to be present within each of the entities, and enabling the user to specify the life span for the entities.

In accordance with the embodiments herein, the step of enabling the user to specify the rules for modeling the entities, further includes the step of specifying the rules selected from the group consisting of validation rules, derivation rules, inheritance rules and event driven rules.

In accordance with the embodiments herein, the method further includes the step of selectively storing at least the values of each of the attributes of each of the entities, the information corresponding to the relationship(s) between the entities, and the information corresponding to the smart attributes.

In accordance with the embodiments herein, the method further includes the step of enabling the user to specify entity relationships selected form the group consisting of one-to-one relationship, one-to-many relationship, many-to-many relationship and self-referential relationship.

The embodiments herein envisage a non transitory computer readable medium having computer readable instructions stored thereupon, the computer readable instructions when executed by a processor, cause a computer enabled device to: enable a user to specify at least the information corresponding to the entities to be modeled; enable the user to specify the rules for modeling the entities; enable the user to dynamically create smart attributes corresponding to the entities, the smart attributes are pre-configured in accordance with the rules for modeling the entities; enable the user to selectively customize the smart attributes; analyze the smart attributes and the rules specified by the user for modeling the entities; dynamically decide upon the relationship(s) between the entities to be modeled; dynamically model an inheritance relationship between the entities; and enable the user to dynamically configure entity level access permissions.

In accordance with the embodiments herein, the computer readable instructions, when executed by a processor are further configured to cause a computer enabled device to: enable the user to specify the attributes to be present within each of the entities, and enable the user to specify the life span for the entities; specify the rules selected from the group consisting of validation rules, derivation rules, inheritance rules and event driven rules; and selectively store at least the values of each of the attributes of each of the entities, the information corresponding to the relationship(s) between the entities, and the, information corresponding to the smart attributes.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 Illustrates a system level block diagram of a computer implemented system for dynamically modeling relationships between a plurality of entities according to one embodiment herein; and

FIG. 2 illustrates a flowchart comprising the steps involved in the method for dynamically modeling relationships between a plurality of entities according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The system envisaged by the embodiments herein allows a user to model the business entities, their attributes, relationships between the business entities and inheritance mechanisms using business rules. The business user can use domain-specific natural language or the Graphical User Interface (GUI) provided by the system of the embodiments herein.

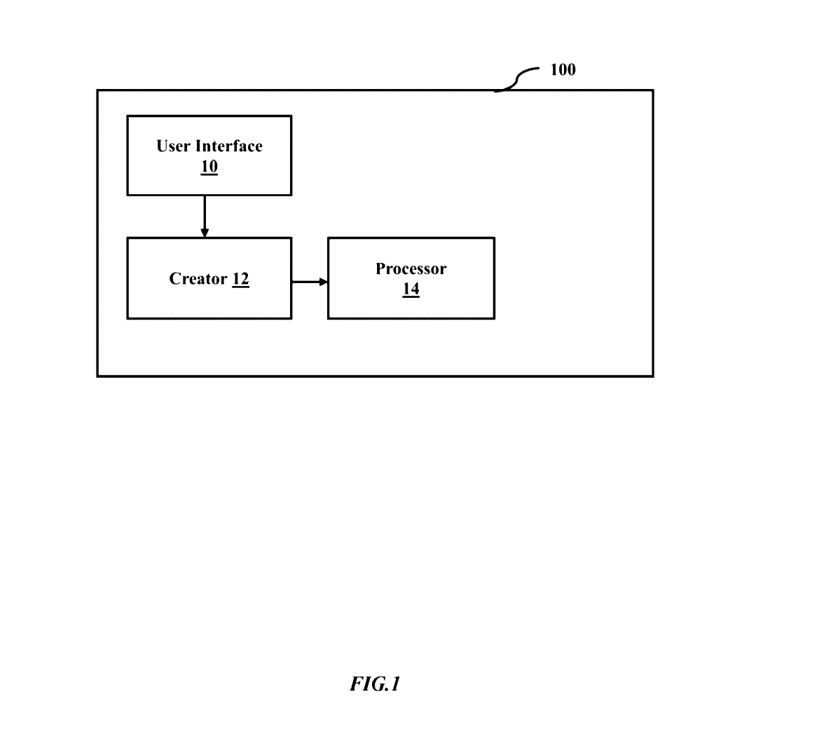

FIG. 1 of the accompanying drawings illustrates a system-level block diagram describing a system 100 for dynamically modeling relationships between a plurality of entities, according to one embodiment herein. The system 100 in accordance with the embodiments herein comprises a user interface 10 which is accessible to the users of the system 100. The user interface 10, in accordance with the embodiments herein enables the user to specify at least the information corresponding to the entities to be modeled and the for modeling the specified entities.

In accordance with the embodiments herein, the user, through the user interface 10 can specify the name of the entity, and describe the entity and also specify whether the entity is a persisted entity or not. Persistent entities are written to a data-store/repository to the transaction is completed, while non-persistent entities have a lifecycle only during the transaction and are destroyed subsequent to the completion of the transaction. The user, can, through the user interface 10 further specify the attributes to be present within the entity, and the relationship between each of the attributes. Typically, Entity attributes are used to drive the entity relationships (i.e.) relationships between two entities are expressed as relationships between specific attributes of those two entities. Further, in accordance with the embodiments herein, the user is also enabled to specify the business rules associated that the entity. The business rules include but are not restricted to the validation rules, derivation rules and event driven rules.

In accordance with the embodiments herein, the validation rules are triggered when the value of the corresponding attribute is changed. Further, the values of the derived attributes are not specified by the user but are calculated using these rules. Further, event driven rules are utilized to trigger business processes for some events related to the value of this attribute. For example, for the Account entity, a business rule can say that when the account balance goes negative, the ‘overdrawn_account’ business process should be triggered. Further, through the user interface 10, the user can also specify the rules to be triggered for different events associated with the entity such as creation of an entity, deletion of an entity, updating an entity and the like.

In accordance with the embodiments herein, the business rules associated with an entity operate at a higher level than the business rules associated with an attribute of that entity. For example, consider a ‘Bank Customer’ entity with attributes including ‘account balance’ and ‘account status’. Account balance can only take a positive value (a validation rule on the attribute ‘balance’) and status can only take values such as ‘gold’, ‘silver’, ‘platinum’ and the like (a validation rule on the attribute ‘status’). But, the validation rule, “If account balance is more than 50,000, then status should be platinum” is associated with the entity Bank Customer. Further, an attribute of an entity can have the properties including but not restricted to ‘data type’, ‘primary key’, ‘unique’, ‘required’, ‘persistent’, ‘identity’, ‘index’, ‘default value’, ‘collection’.

In accordance with the embodiments herein, the attribute data type denotes the type of the attribute data. The basic data types allowed Boolean, character, string, date or numeric. Further, the property ‘primary key’ is included in the set of primary keys for the corresponding entity. The property ‘unique’ determines whether the value of an attribute should remain unique (i.e.) two entities cannot have the same value for this attribute. The property ‘required’ denotes that a value is required to be associated with the attribute and that it cannot be a NULL value. The property ‘persistent’ denotes that the value of the attribute is always written to the data-store/repository. The property ‘identity’ is an auto-generated field whose value is generated by the system when the entity is created. The property ‘index’ denotes that the values for the attribute are indexed and used for quick retrieval. The property ‘default value’ indicates that an initial value is to be assigned to the attribute when the entity is created. The property ‘collection’ indicates that the attribute is a collection which holds many values with the same data type. All the attribute rules and properties will be applied to all values in the collection.

In accordance with the embodiments herein, the system 100 further includes a creator 12. The creator 12, which is also accessible to the user, enables the user to dynamically create smart attributes corresponding to the entities. In accordance with the embodiments herein, the smart attributes are pre-configured in accordance with the rules for modeling the entities.

In accordance with the embodiments herein, ‘smart attributes’ are the attributes for which business rules have been pre-configured. The creator 12 enables business users to acid instances of the ‘smart’ attributes to any business entity. For example, if an email address is taker into consideration, a smart attribute for email address would have validation rules to ensure that the email address is valid. A process for transmitting an email receives an attribute of type ‘email address’ as input. The creator 12 enables the user to create new instances of the ‘email address’ smart attribute and associate those instances to various entities (for example, a customer entity, a subscriber entity).

In accordance with the embodiments herein, the smart attributes are preconfigured in accordance with the business rules for modeling the entities. The business rules can refer to the value of other attributes in an entity or a plurality of related entities. For example, the system 100 supports basic arithmetic operators including but not restricted to ‘SUM’, ‘AVG’, ‘COUNT’ and the like.

In accordance with the embodiments herein, the creator 12 further enables a user to generate custom smart attributes and include them into a library of smart attributes. The library of smart attributes would comprise pre-built smart attributes provided by the system 100, and the custom smart attributes, typically created by the users. The instances of both pre-built smart attributes, and the custom attributes is also made accessible to the user (by the creator 12) for the purpose of modeling the business entities.

In accordance with the embodiments herein, the system 100 further comprises a processor 14. The processor 14 is configured to analyze at least the smart attributes and the rules specified by the user for modeling the entities. Subsequent to the analysis of the smart attributes and the entity modeling rules, the processor dynamically decides upon the relationship(s) between the entities to be modeled.

Typically, attributes in one entity relate to attributes in another entity, thereby establishing entity relationships. An entity relationship can be a one-to-many relationship wherein one entity is related to one or more other entities. For example, ‘Customer’ is an entity type with attribute called ‘customer_id’ set as the primary key. ‘Account’ is another entity type. The entity ‘Account’ also includes an attribute called ‘customer_id’ which is related to the ‘customer_id’ attribute in the ‘Customer’ entity. Such a relationship is termed as a one-to-many relationship between the ‘Customer’ entity and ‘Account’ entity, since one or more accounts can be related to the same customer. Further, an entity relationship can also be a one-to-one relationship, wherein one particular entity is related to only one other entity. For example, if we were reconsider the aforementioned example, if the customer_id attribute in ‘Account’ entity had the ‘unique’ property enabled, it would establish a one-to-one relationship between Customer and Account as one particular customer tail have only one unique account.

Further, a relationship can be classified as a many-to-many relationship if it includes entities having one-to-many relationships with multiple entities. For example, if a book lending library is considered, the entity ‘Customer’ and the entity ‘Book’ needs to be related using a many-to-many relationship (i.e.) one customer can view more than one book and one book can be viewed by more than one customer. Subsequently, a new entity ‘Lent-Books’ can be introduced with a one-to-many relationship from the entity ‘Customer’ to ‘Lent-Books’ and another one-to-many relationship can be introduced from the entity ‘Book’ to ‘Lent-Books’, thereby effectively creating a many-to-many relationship between the entity ‘Customer’ and entity ‘Book’.

Further, a relationship can be classified as self-referential relationship wherein the Entity type is related to itself. This relationship is established when one attribute in the entity type is related to another attribute within the same entity type.

In accordance with the embodiments herein, the processor 14 is configured to dynamically determine whether a relationship between entities should exist. The processor 14 is configured to dynamically configure the relationship(s) between the entities using the business rules specified by the user. For example, an entity ‘person’ is linked by processor 14 to the entity ‘company’ only when the processor determines that the variable ‘isEmployed’ is set to ‘true’. For example, an entity ‘Customer’ can have relationships (one to many) with entity ‘Accounts’ Only when the corresponding customer is registered.

In accordance with the embodiments herein, the system 100 also supports inheritance mechanism and enables the user to establish inheritance relationships (‘is A’) between the entities. For example, the system 100 allows for an entity of type ‘Person’ to be defined with. attributes and rules for generic utilization. The system 100 further creates an entity type ‘Student’ which inherits from the parent entity type ‘Person’, the attributes, business rules and other properties, thereby indicating that ‘Student’ is a type of ‘Person’. The system 100 enables additional attributes and business rules to be defined for the entity type ‘Student’ and for certain inherited properties to be overridden.

Further, the system 100 enables (via the user interface 10) the user to define inheritance rules for every inheritance relationship. The system 100 enables the user to define which attributes, business rules and properties are to be inherited from a parent entity to a child entity, define a mechanism by which inherited properties could be overridden, and define the conflict resolution mechanism to handle inheritance from two different parent entity types.

In accordance with the embodiments herein, the processor 14 selectively makes use of the business rules to dynamically configure inheritance rules. For example, a data object of type ‘Magazine’ will have an object reference of type ‘PricingPlan’ only when the expression (isForSale=true) is satisfied.

In accordance with the embodiments herein, the processor 14 incorporates a fine grained permission mechanism, thereby enabling the user to iteratively configure the permissions for viewing, creating, updating, deleting a plurality of entities and the corresponding attributes. The processor 14 also enables dynamic configuration of the aforementioned permissions based on the business rules. For example, the permissions can be configured such that a given Region Manager can only view entities of type Customer in which the attribute region matches the region he is in charge of. If the value of the ‘region’ attribute changes, the permissions for that entity are also changed appropriately.

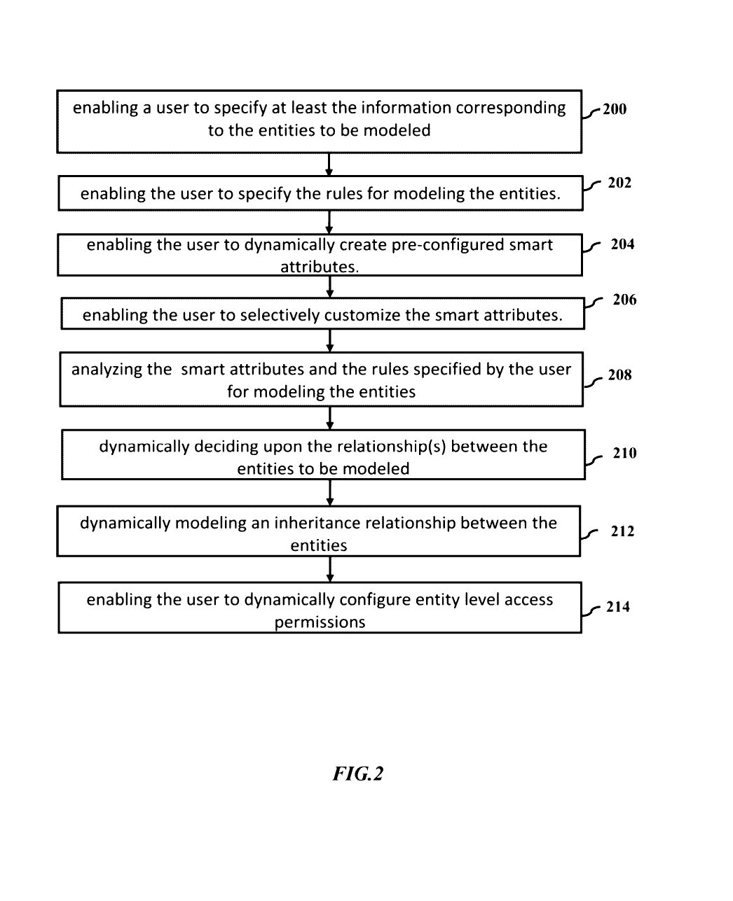

In accordance with the embodiments herein. FIG. 2 illustrates a flowchart corresponding to the computer implemented method for dynamically modeling relationships between a plurality of entities. The method, in accordance with the embodiments herein comprises the following computer implemented steps: enabling a user to specify at least the information corresponding to the entities to be modeled 200; enabling the user to specify the rules for modeling the entities 202; enabling the user to dynamically create smart attributes corresponding to the entities, wherein the smart attributes are pre-configured in accordance with the rules for modeling, the entities 204; enabling the user to selectively customize the smart attributes 206; analyzing the smart attributes and the rules specified by the user for modeling the entities 208; dynamically deciding upon the relationship(s) between the entities to be modeled 210; dynamically modeling n inheritance relationship between the entities 212; and enabling the user to dynamically configure entity level access permissions 214.

In accordance with the embodiments herein, the step of enabling a user to specify at least the information corresponding to the entities to be modeled, further includes the step of enabling the user to specify the attributes to be present within each of the entities, and enabling the user to specify the life span for the entities.

In accordance with the embodiments herein, the step of enabling the user to specify the rules for modeling the entities, further includes the step of specifying the rules selected from the group consisting of validation rules, derivation rules, inheritance rules and event driven rules.

In accordance with the embodiments herein, the method further includes the step of selectively storing at least the values of each of the attributes of each of the entities, the information corresponding to the relationship(s) between the entities, and the information corresponding to the smart attributes.

In accordance with the embodiments herein, the method further includes the step of enabling the user to specify entity relationships selected form the group consisting of one-to-one relationship, one-to-many relationship, many-to-many relationship and self-referential relationship.

Further, the embodiments herein envisages a non transitory computer readable medium having computer readable instructions stored thereupon, the computer readable instructions when executed by a processor, cause a computer enabled device to: enable a user to specify at least the information corresponding to the entities to be modeled; enable the user to specify the rules for modeling the entities; enable the user to dynamically create smart attributes corresponding to the entities, the smart attributes are pre-configured in accordance with the rules for modeling the entities; enable the user to selectively customize the smart attributes; analyze the smart attributes and the rules specified by the user for modeling the entities; dynamically decide upon the relationship(s) between the entities to be modeled; dynamically model an inheritance relationship between the entities; and enable the user to dynamically configure entity level access permissions.

In accordance with the embodiments herein, the computer readable instructions, when executed by a processor are further configured to cause a computer enabled device to: enable the user to specify the attributes to be present within each of the entities, and enable the user to specify the life span for the entities; specify the rules selected from the group consisting of validation rules, derivation rules, inheritance rules and event driven rules; and selectively store at least the values of each of the attributes of each of the entities, the information corresponding to the relationship(s) between the entities, and the information corresponding to the smart attributes.

The technical advantages envisaged by the embodiments herein include the realization of a system that dynamically models the relationships between the entities. The system envisaged by the embodiments herein provides smart attributes to enable users to seamlessly design E-R models. The system details the different inheritance models used between various entities. The system also enables users to model entity relationships using domain specific languages. The system also enables users to specify fine grained permissions for performing predetermined entity (attribute) level functions.

The foregoing description of the specific embodiments revealed the general nature of the embodiments herein that others can, by applying current knowledge, readily modify and/or adapt for various applications such specific embodiments without departing from the generic concept, and therefore, such adaptations and modifications should and are intended to be comprehended within the meaning and range of equivalents of the disclosed. embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the embodiments herein with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A computer implemented system for dynamically modeling relationships between a plurality of entities, said system comprising:
a user interface accessible to a user, said user interface configured to enable the user to specify at least the information corresponding to the entities to be modeled; the user interface further configured to enable the user to specify the rules for modeling the entities;
a creator accessible to the user, said creator configured to enable the user to dynamically create smart attributes corresponding to the entities, wherein said smart attributes are pre-configured in accordance with the rules for modeling the entities, said creator further configured to enable the user to selectively customize the smart attributes;
a processor cooperating with said creator, said processor configured to analyze the smart attributes and the rules specified by the user for modeling the entities, said processor configured to dynamically decide upon the relationship(s) between the entities to be modeled;
wherein said system is configured to dynamically model an inheritance relationship between the entities, said system further configured to enable the user to dynamically configure entity level access permissions.

2. The system as claimed in claim 1, wherein said graphical user interface is further configured to enable the user to specify the attributes to be present within each of the entities, said user interface further enabling the user to specify the life cycle for the entities.

3. The system as claimed in claim 1, wherein the user interface enables the user to specify the rules for modeling the entities, said rules selected from the group consisting of validation rules, derivation rules, inheritance rules and event driven rules.

4. The system as claimed in claim 1, wherein said system includes a data storage mechanism configured to selectively store at least the values of each of the attributes of each of the entities, and the information corresponding to the relationship(s) between the entities, and the information corresponding to the smart attributes.

5. The system as claimed in claim 1, wherein said user interface further enables a user to specify entity relationships including one-to-one relationship, one-to-many relationship, many-to-many relationship and self-referential relationship.

6. The system as claimed in claim 1, wherein said user interface is a natural language based text editor.

7. A computer implemented method for dynamically modeling relationships between a plurality of entities, said method comprising the following computer implemented steps:
enabling a user to specify at least the information corresponding to the entities to be modeled;
enabling the user to specify the rules for modeling the entities;
enabling the user to dynamically create smart attributes corresponding to the entities, said smart attributes are pre-configured in accordance with the rules for modeling the entities;
enabling the user to selectively customize the smart attributes;
analyzing the smart attributes and the rules specified by the user for modeling the entities; and
dynamically deciding upon the relationship(s) between the entities to be modeled;
dynamically modeling an inheritance relationship between the entities; and
enabling the user to dynamically configure entity level access permissions.

8. The method as claimed in claim 7, wherein the step of enabling a user to specify at least the information corresponding to the entities to be modeled, further includes the step of enabling the user to specify the attributes to be present within each of the entities, and enabling the user to specify the life span for the entities.

9. The method as claimed in claim 7, wherein the step of enabling the user to specify the rules for modeling the entities, further includes the step of specifying the rules selected from the group consisting of validation rules, derivation rules, inheritance rules and event driven rules.

10. The method as claimed in claim 7, wherein the method further includes the step of selectively storing at least the values of each of the attributes of each of the entities, the information corresponding to the relationship(s) between the entities, and the information corresponding to the smart attributes.

11. The method as claimed in claim 7, wherein the method further includes the step of enabling the user to specify entity relationships selected form the group consisting of one-to-one relationship, one-to-many relationship, many-to-many relationship and self-referential relationship.

12. A non transitory computer readable medium having computer readable instructions stored thereupon, the computer readable instructions when executed by a processor, configured to cause a computer enabled device to:
enable a user to specify at least the information corresponding to the entities to be modeled;
enable the user to specify the rules for modeling the entities;
enable the user to dynamically create smart attributes corresponding to the entities, said smart attributes are pre-configured in accordance with the rules for modeling the entities;
enable the user to selectively customize the smart attributes;
analyze the smart attributes and the rules specified by the user for modeling the entities; and
dynamically decide upon the relationship(s) between the entities to be modeled;
dynamically model an inheritance relationship between the entities; and
enable the user to dynamically configure entity level access permissions.

13. The non transitory computer readable medium as claimed in claim 12, wherein the computer readable instructions, when executed by a processor are further configured to cause a computer enabled device to
enable the user to specify the attributes to be present within each of the entities, and enable the user to specify the life span for the entities;
specify the rules selected from the group consisting of validation rules, derivation rules, inheritance rules and event driven rules; and
selectively store at least the values of each of the attributes of each of the entities, the information corresponding to the relationship(s) between the entities, and the information corresponding to the smart attributes.
